(19) United States
(12) Patent Application Publication
(10) Pub. No.: US 2017/0094294 A1
(43) Pub. Date: Mar. 30, 2017

(54) VIDEO ENCODING AND DECODING WITH BACK CHANNEL MESSAGE MANAGEMENT

(71) Applicant: Cybrook Inc., Santa Clara, CA (US)

(72) Inventor: Qunshan GU, Santa Clara, CA (US)

(21) Appl. No.: 14/982,698

(22) Filed: Dec. 29, 2015

Related U.S. Application Data
(63) Continuation-in-part of application No. 14/867,143, filed on Sep. 28, 2015.

(51) Int. Cl. H04N 19/44; H04N 19/895; H04N 19/65

(52) U.S. Cl. CPC H04N 19/44; H04N 19/65; H04N 19/895

(57) ABSTRACT

Systems, apparatuses and methods for decoding and encoding a video bitstream with a computing device are disclosed. The method for encoding includes receiving, from a decoding computing device, data for encoding the video bitstream; determining encoding parameters based on the data for encoding the video bitstream; determining, by the computing device and for encoding a current frame of the video bitstream, a selected reference frame from reference frames preceding the current frame in display order, the reference frames comprising a good reference frame, wherein the good reference frame is a reference frame known to the encoder to be error-free; and encoding the current frame of the video bitstream using the selected reference frame and the encoding parameters.

### CROSS-REFERENCE TO RELATED APPLICATION(S)

This application is a continuation-in-part of pending U.S. patent application Ser. No. 14/867,143, filed Sep. 28, 2015, the disclosure of which is incorporated herein by reference in its entirety.

### TECHNICAL FIELD

This disclosure relates to video encoding and decoding and particularly to video coding and decoding using back channel messaging for real-time video transmission.

### BACKGROUND OF THE INVENTION

Digital video streams can be encoded to efficiently compress the video into a digital bitstream for storage on non-transitory digital media or streaming transmission through bandwidth-limited communication channels. However, packet loss and other errors can occur during video bitstream transmission or storage, resulting in errors in decoding the bitstream. It is also common that the available channel bandwidth can change from time to time, causing problems in real-time video transmission.

### SUMMARY OF THE INVENTION

This disclosure includes aspects of systems, methods and apparatuses for video encoding and decoding with back channel message management.

In one aspect, this disclosure includes a method for encoding a video bitstream with a computing device, comprising receiving data for encoding the video bitstream, determining encoding parameters based on the data for encoding the video bitstream, determining a selected reference frame for encoding a current frame of the video bitstream from reference frames preceding the current frame in display order, the reference frames comprising a good reference frame that is a reference frame known to the encoder to be error-free, and encoding the current frame of the video bitstream using the selected reference frame and the encoding parameters. In some implementations, for a reference frame to be a good reference frame, the needed reference frames (e.g., reference frames needed for decoding when multiple reference frames are used) are also without any error.

In another aspect, this disclosure includes a method for decoding a video bitstream with a computing device comprising transmitting data for encoding the video bitstream, receiving the encoded bitstream that comprises a current frame encoded using a selected reference frame from reference frames preceding the current frame in display order, the reference frames comprising a good reference frame, wherein the good reference frame is a reference frame known to the encoder to be error-free, and decoding the video bitstream using the selected reference frame.

In another aspect, this disclosure includes an apparatus for encoding a video bitstream comprising a memory and a processor. The processor is operative to execute instructions stored in the memory to receive data for encoding the video bitstream, determine encoding parameters based on the data for encoding the video bitstream, determine a selected reference frame for encoding a current frame of the video bitstream from reference frames preceding the current frame in display order, the reference frames comprising a good reference frame that is a reference frame known to the encoder to be error-free, and encode the current frame of the video bitstream using the selected reference frame and the encoding parameters.

These and other aspects are described in additional detail below.

### BRIEF DESCRIPTION OF THE DRAWINGS

This disclosure refers to the accompanying drawings, where like reference numerals refer to like parts throughout the several views and wherein:

FIG. 1 is a schematic of a video encoding and decoding system in accordance with aspects of disclosed implementations;

FIG. 2 is a diagram of a video stream in accordance with aspects of disclosed implementations;

FIG. 3 is a block diagram of a video compression system in accordance with aspects of disclosed implementations;

FIG. 4 is a block diagram of a video decompression system in accordance with aspects of disclosed implementations;

FIG. 5 is a flowchart showing video decoding processing in accordance with aspects of disclosed implementations;

FIG. 6 is a flowchart showing video decoding processing in accordance with aspects of disclosed implementations;

FIG. 7 is a flowchart showing video encoding processing in accordance with aspects of disclosed implementations;

FIG. 8 is a flowchart showing video encoding processing in accordance with aspects of disclosed implementations;

FIG. 9 is a diagram of a video encoding and decoding system including a back channel message manager in accordance with aspects of disclosed implementations;

FIG. 10 shows diagrams of encoding and decoding reference frame selection in accordance with aspects of disclosed implementations; and

FIG. 11 is a diagram showing a video reference frame structure in accordance with aspects of disclosed implementations.

### DETAILED DESCRIPTION

Digital video is can be used for entertainment, video conferencing, advertising and general information sharing. User expectation for digital video quality can be high, as users expect video over shared internet networks with limited bandwidth to have the same high spatial and temporal quality as video broadcast over dedicated cable channels. Digital video encoding can compress a digital video bitstream to permit high quality digital video to be transmitted over a network having limited bandwidth, for example. Digital video quality can be defined as the degree to which output decompressed and decoded digital video matches the input digital video, for example.

Video encoding and decoding incorporate techniques that compress and decompress digital video streams to permit transmission of high quality digital video streams over networks that can have limited bandwidth capability. These techniques can treat digital video streams as sequences of blocks of digital data and process the blocks to compress the data for transmission or storage and, once received, decompress the blocks to re-create the original digital video stream. This compression and de-compression sequence can be “lossy” in the sense that the de-compressed digital video might not exactly match the input digital video. This can be measured by measuring the difference between pixel data in the input video stream and corresponding pixels in the encoded, transmitted and decoded video stream, for example. The amount of distortion introduced into a digital video stream by encoding and decoding the digital video stream can be a function of the amount of compression, thus the quality of the decoded video can be viewed as a function of the transmission bandwidth.

Aspects of disclosed implementations can permit transmission of compressed video bitstreams over “noisy” or potentially error inducing networks by adjusting the bitrate of the transmitted video bitstream to match the capacity of the channel or network over which it is transmitted. Aspects can test the network prior to transmitting compressed digital video bitstreams by transmitting one or more data packets to a decoder and analyzing return packets to determine an optimal compression ratio for the digital video. Aspects can periodically re-test the network by analyzing data packets sent by the decoder (or receiver) to the encoder (or sender) that include information regarding the network. Adjusting the bitrate can increase or decrease the spatial and temporal quality of the decoded video bitstream as compared to the input digital video stream, where higher bitrates can support higher quality digital video.

Aspects of disclosed implementations can also transmit compressed video bitstreams over noisy networks by adding forward error correction (FEC) packets to the compressed video bitstream. FEC packets redundantly encode some or all of the information in a digital video bitstream in additional packets included in the bitstream. By processing the additional packets, a decoder can detect missing or corrupt information in a digital video stream and, in some cases, reconstruct the missing or corrupt data using the redundant data in the additional packets. Aspects can adjust parameters associated with FEC based on network information packets received by the encoder as discussed above. Adjusting the FEC parameters dynamically can divide available network bandwidth between transmitting digital video data and FEC data to permit the maximum quality image per unit time to be transmitted under given network conditions.

Aspects of disclosed implementations can change encoder and FEC parameters to permit the highest quality possible digital video to be transmitted for given network conditions as the digital video bitstream is being transmitted. Changing these parameters can also affect the quality of the decoded video stream, since they can cause rapid changes in the appearance of the decoded video as it is being viewed. Aspects can control the changes in encoder and FEC parameters to avoid rapid changes in video quality by analyzing trends in parameter changes and anticipating changes in parameter values.

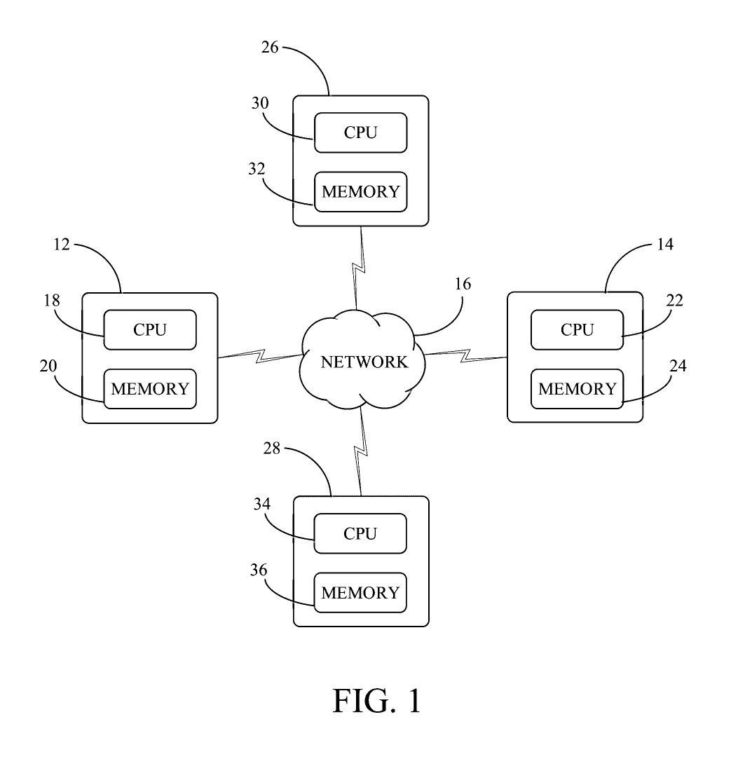

FIG. 1 is a schematic of a video encoding and decoding system 10 in which aspects of the invention can be implemented. A computing device 12, in one example, can include an internal configuration of hardware including a processor such as a central processing unit (CPU) 18 and a digital data storage exemplified by memory 20. CPU 18 can a controller for controlling the operations of computing device 12, and can be a microprocessor, digital signal processor, field programmable gate array, discrete circuit elements laid out in a custom application specific integrated circuit (ASIC), or any other digital data processor, for example. CPU 18 can be connected to memory 20 by a memory bus, wires, cables, wireless connection, or any other connection, for example. Memory 20 can be or include read-only memory (ROM), random access memory (RAM), optical storage, magnetic storage such as disk or tape, non-volatile memory cards, cloud storage or any other manner or combination of suitable digital data storage device or devices. Memory 20 can store data and program instructions that are used by CPU 18. Other suitable implementations of computing device 12 are possible. For example, the processing of computing device 12 can be distributed among multiple devices communicating over multiple networks 16.

In one example, a network 16 can connect computing device 12 and computing device 14 for encoding and decoding a video stream. For example, the video stream can be encoded in computing device 12 and the encoded video stream is decoded in computing device 14. Network 16 can include any network or networks that are appropriate to the application at hand, such as wired or wireless local or wide area networks, virtual private networks, cellular telephone data networks, or any other wired or wireless configuration of hardware, software, communication protocol suitable to transfer a video bitstream from computing device 12 to computing device 14 and communicate parameters regarding the network from computing device 14 to computing device 12 in the illustrated example.

Computing device 14 can includes CPU 22 and memory 24, which can be similar to components as discussed above in conjunction with the system 12. Computing device 14 can be configured to display a video stream, for example. A display connected to computing device 14 and can be implemented in various ways, including by a liquid crystal display (LCD), a cathode-ray tube (CRT), organic or non-organic light emitting diode display (LED), plasma display, or any other mechanism to display a machine-readable video signal to a user. Computing device 14 can be configured to display a rendering of the video bitstream decoded by a decoder in computing device 14, for example.

Other implementations of encoder and decoder system 10 are possible. In addition to computing device 12 and computing device 14, FIG. 1 shows additional computing devices 26, 28 each having one or more CPUs 30, 34 and memories 32, 36 respectively. These computing devices can include servers, and mobile phones, which can also create, encode, decode, store, forward or display digital video streams, for example. Each of these computing devices can have differing capabilities in terms of processing power and memory availability, including devices for creating video such as video cameras and devices for displaying video.

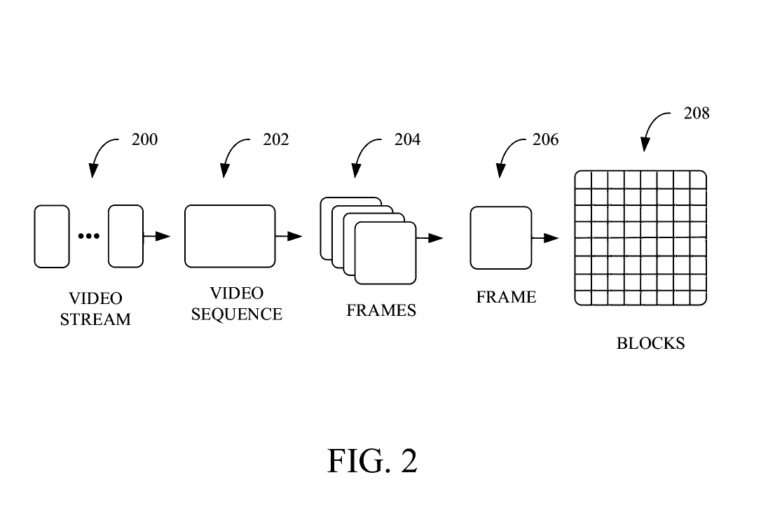

FIG. 2 is diagram of an video stream 300 to be encoded and subsequently decoded. Video stream 200 can include a video sequence 202. A video sequence 200 is a temporally contiguous subset of a video stream, also called a group of pictures (GOP). Video sequence 202 can include a number of adjacent video frames 204. While four frames are depicted in adjacent frames 204, video sequence 202 can include any number of adjacent frames. A single example of the adjacent frames 204 is illustrated as the single frame 206. Further sub-dividing the single frame 206 can yield a series of blocks 208. In this example, blocks 208 can contain data corresponding to an N×M pixel region in frame 206, such as luminance and chrominance data for the corresponding pixels. Blocks 208 can be of any suitable size such as 128×128 pixel groups or any rectangular subset of the pixel group.

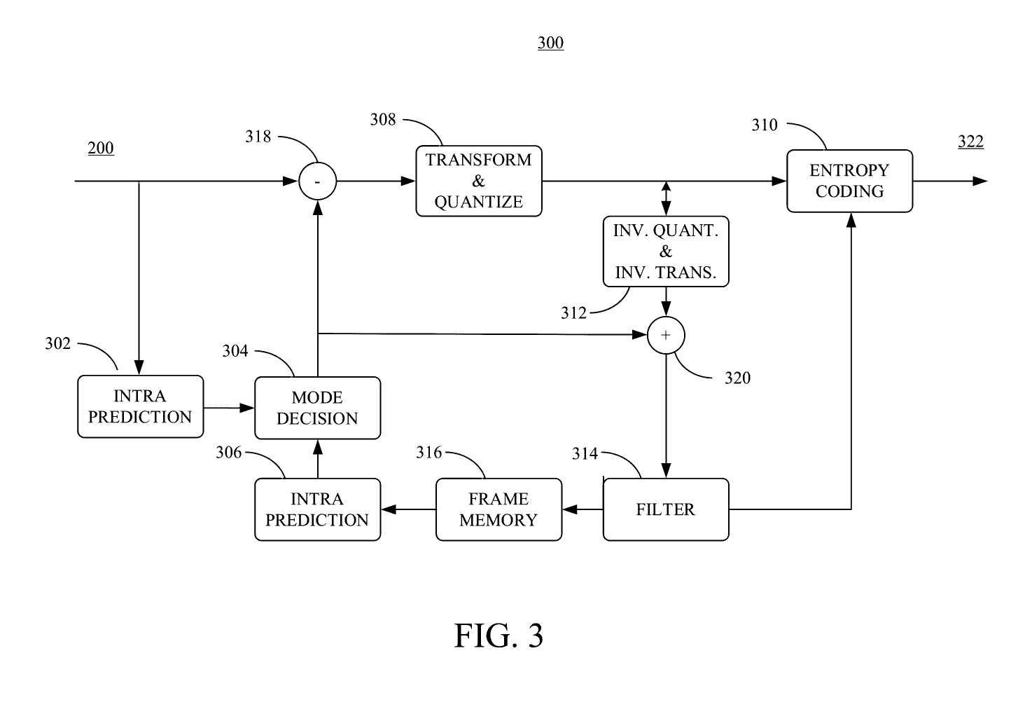

FIG. 3 is a block diagram of an encoder 300 in accordance with disclosed implementations. Encoder 300 can be implemented in a computing device such as computing device 12. Encoder 300 can encode an input video stream 200. Encoder 300 includes stages to perform the various functions in a forward path to produce an encoded and/or a compressed bitstream 322: an intra prediction stage 302, mode decision stage 304, an inter prediction stage 306, transform and quantization stage 308, a filter stage 314 and an entropy encoding stage 40. Encoder 300 can also include a reconstruction path to reconstruct a frame for prediction and encoding of future blocks. In FIG. 3, encoder 300 includes an inverse quantization and inverse transform stage 312 and a frame memory 316 that can be used to store multiple frames of video data to reconstruct blocks for prediction. Other structural variations of encoder 300 can be used to encode video stream 200.

When video stream 200 is presented for encoding, each frame (such as frame 206 from FIG. 2) within video stream 200 is processed in units of blocks. Each block can be processed separately in raster scan order starting from the upper left hand block. At intra prediction stage 302 intra prediction residual blocks can be determined for the blocks of video stream 200. Intra prediction can predict the contents of a block by examining previously processed nearby blocks to determine if the pixel values of the nearby blocks are similar to the current block. Since video streams 200 are processed in raster scan order, blocks that occur in raster scan order ahead of the current block are available for processing the current block. Blocks that occur before a given block in raster scan order can be used for intra prediction because they will be available for use at a decoder since they will have already been reconstructed. If a nearby block is similar enough to the current block, the nearby block can be used as a prediction block and subtracted 318 from the current block to form a residual block and information indicating that the current block was intra-predicted can be included in the video bitstream.

Video stream 200 can also be inter predicted at inter prediction stage 306. Inter prediction includes forming a residual block from a current block by translating pixels from a temporally nearby frame to form a prediction block that can be subtracted 318 from the current block. Temporally adjacent frames can be stored in frame memory 316 and accessed by inter prediction stage 306 to form a residual block that can be passed to mode decision stage 304 where the residual block from intra prediction can be compared to the residual block from inter prediction. The mode decision stage 302 can determine which prediction mode, inter or intra, to use to predict the current block. Aspects can use rate distortion value to determine which prediction mode to use, for example.

Rate distortion value can be determined by calculating the number or bits per unit time or bit rate of a video bitstream encoded using particular encoding parameter, such as prediction mode, for example, combined with calculated differences between blocks from the input video stream and blocks in the same position temporally and spatially in the decoded video stream. Since encoder 300 is “lossy”, pixel values in blocks from the decoded video stream can differ from pixel values in blocks from the input video stream. Encoding parameters can be varied and respective rate distortion values compared in order to determine optimal parameter values, for example.

At subtraction stage 318 the residual block determined by mode decision stage 304 can be subtracted from the current block and passed to transform and quantize stage 308. Since the values of the residual block can be smaller than the values in the current block, the transformed and quantized 308 residual block can have fewer values than the transformed and quantized 308 current block and therefore be represented by fewer transform coefficients in the video bitstream. Examples of block-based transforms include the Karhunen-Loéve Transform (KLT), the Discrete Cosine Transform (“DCT”), and the Singular Value Decomposition Transform (“SVD”) to name a few. In one example, the DCT transforms the block into the frequency domain. In the case of DCT, the transform coefficient values are based on spatial frequency, with the DC or other lowest frequency coefficient at the top-left of the matrix and the highest frequency coefficient at the bottom-right of the matrix.

Transform and quantize stage 308 converts the transform coefficients into discrete quantum values, which can be referred to as quantized transform coefficients. Quantization can reduce the number of discrete states represented by the transform coefficients while reducing image quality less than if the quantization were performed in the spatial domain rather than a transform domain. The quantized transform coefficients can then entropy encoded by entropy encoding stage 310. Entropy encoding is a reversible, lossless arithmetic encoding scheme that can reduce the number of bits in the video bitstream that can be decoded without introducing change in the bitstream. The entropy-encoded coefficients, together with other information used to decode the block, such as the type of prediction used, motion vectors, quantizer value and filter strength, are then output as a compressed bitstream 322.

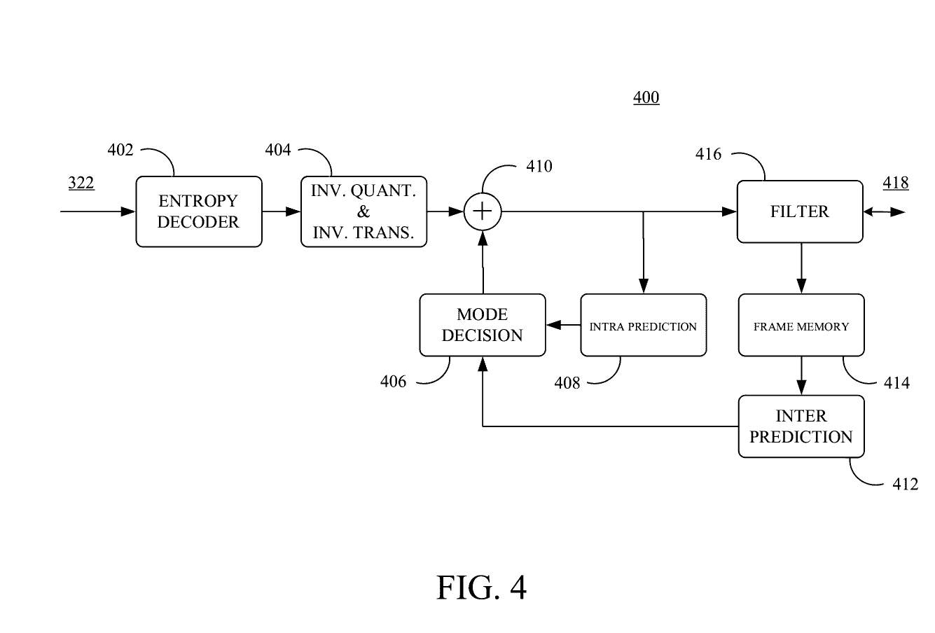

The reconstruction path in FIG. 3, shown by the dotted connection lines, can be used to help ensure that both encoder 300 and decoder 400 (described below with reference to FIG. 4) use the same reference frames to form intra prediction blocks. The reconstruction path performs functions that are similar to functions performed during the decoding process discussed in more detail below, including dequantizing and inverse transforming the quantized transform coefficients at inverse quantize and inverse transform stage 312, which can be combined with a residual block from mode decision stage 304 at adder 320 to create a reconstructed block. Loop filter stage 314 can be applied to the reconstructed block to reduce distortion such as blocking artifacts since decoder 400 can filter the reconstructed video stream prior to sampling it to form reference frames. FIG. 3 shows loop filter stage 314 sending loop filter parameters to entropy coder 310 to be combined with output video bitstream 322, to permit decoder 400 to use the same loop filter parameters as encoder 300, for example.

Other variations of encoder 300 can be used to encode compressed bitstream 322. Encoder 300 stages can be processed in different orders or can be combined into fewer stages or divided into more stages without changing the purpose. For example, a non-transform based encoder 300 can quantize the residual signal directly without transform stage. In another implementation, an encoder 300 can have transform and quantize stage 308 divided into a single stage.

FIG. 4 is a block diagram of decoder 400 in according to aspects of disclosed implementations. In one example, decoder 400 can be implemented in computing device 14. Decoder 400 includes the following stages to perform various functions to produce an output video stream 418 from compressed bitstream 322: entropy decoding stage 402, an inverse quantization and inverse transform stage 404, an intra prediction stage 408, an inter prediction stage 412, an adder 410, a mode decision stage 406 and a frame memory 414. Other structural variations of decoder 400 can be used to decode compressed bitstream 322. For example, inverse quantization and inverse transform stage 404 can be expressed as two separate stages.

Received video bitstream 322 can be entropy decoded by entropy decoder 402. Entropy decoder 402 performs an inverse of the entropy coding performed at stage 310 of the encoder 300 to restore the video bitstream to its original state before entropy coding. The restored video bitstream can then be inverse quantized and inverse transformed in similar fashion to inverse quantize and inverse transform stage 312. Inverse quantize and inverse transform stage 404 can restore residual blocks of the video bitstream 322. Note that since encoder 300 and decoder 400 can represent lossy encoding, the restored residual block can have different pixel values than the residual block from the same temporal and spatial location in the input video stream 200.

Following restoration of residual blocks at inverse quantize and inverse transform stage 404, the residual blocks of the video bitstream can be then restored to approximate its pre-prediction state by adding prediction blocks to the residual blocks at adder 410. Adder 410 receives the prediction block to be added to residual blocks at stage 410 from the mode decision stage 406. Mode decision stage 406 can interpret parameters included in the input video bitstream 322 by encoder 300, for example, to determine whether to use intra or inter prediction to restore a block of the video bitstream 322. Mode decision stage 406 can also perform calculations on the input video bitstream 322 to determine which type of prediction to use for a particular block. By performing the same calculations on the same data as the decoder, mode decision state 406 can make the same decision regarding prediction mode as the encoder 300, thereby reducing the need to transmit bits in the video bitstream to indicate which prediction mode to use.

Mode decision stage 406 can receive prediction blocks from both intra prediction stage 408 and inter prediction stage 412. Intra prediction stage 408 can receive blocks to be used as prediction blocks from the restored video stream output from adder 410 since intra prediction blocks are processed in raster scan order, and since blocks used in intra prediction are selected by encoder 300 to occur in the raster scan order before the residual block to be restored occur, intra prediction stage 408 can provide prediction blocks when required. Inter prediction stage 412 creates prediction blocks from frames stored in frame memory 414 as discussed above in relation to encoder 200. Frame memory 414 receives reconstructed blocks after filtering by loop filter 418. Loop filtering can remove blocking artifacts introduced by block-based prediction techniques such as used by encoder 300 and decoder 400 as described herein.

Inter prediction stage 412 can use frames from frame memory 414 following filtering by loop filter 418 in order to use the same data for forming prediction blocks as was used by encoder 300. Using the same data for prediction permits decoder 400 to reconstruct blocks to have pixel values close to corresponding input blocks in spite of using lossy compression. Prediction blocks from inter prediction stage 412 are received by mode decision stage 406 can be passed to adder 410 to restore a block of video bitstream 322. Following loop filtering by loop filter 416, restored video stream 418 can be output from encoder 400. Other variations of decoder 400 can be used to decode compressed bitstream 322. For example, decoder 400 can produce output video stream 418 without loop filter stage 416.

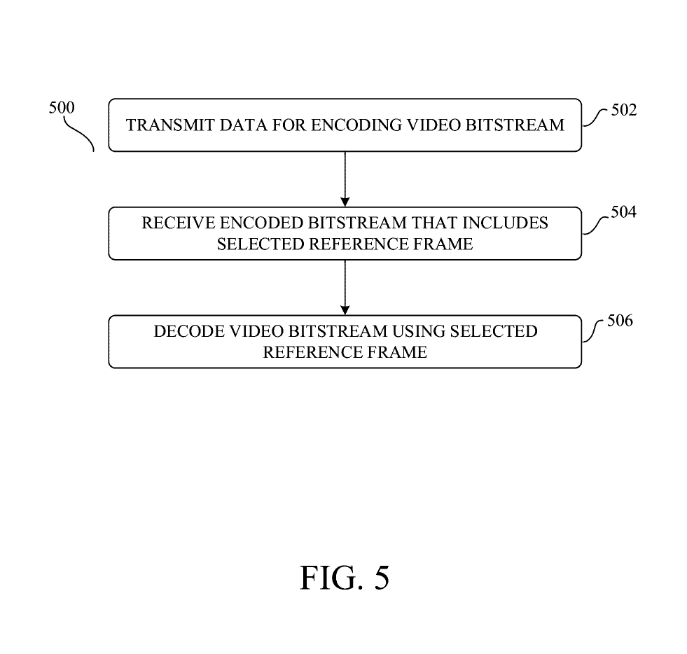

FIG. 5 is a flowchart showing a process 500 for decoding a video bitstream in accordance with disclosed implementations. Process 500 can be performed by a decoding computing device 14 for example. The flowchart diagram in FIG. 5 shows several operations included in process 500. Process 500 can be accomplished with the operations included herein or with more or fewer operations than included here. For example, operations can be combined or divided to change the number of operations performed. The operations of process 500 can be performed in the order included herein or in different orders and still accomplish the intent of process 500.

Process 500 begins at operation 502 by first transmitting, to an encoding computing device, data for encoding the video bitstream. The data for encoding the video bitstream can include, for example, packet loss ratio, round trip delay, receiving bitrate, bandwidth data, data indicating whether a reference frame is good or bad, or any combination of the above. The received data can be used to determine encoding parameters by encoding computing device 12. Other data that purports such use is not limited to the description set forth herein.

Data for encoding the video bitstream can include, for example, feedback data that can be used to form an initial bandwidth estimate. For example, the data can include video data to be decoded or packets artificially packed with random data, such as Call and Answer messages exchanged between an encoding process and decoding process described in details later in this disclosure.

At a step 504, the encoded bitstream is received, at the computing device 14, from the encoding computing device, and the encoded bitstream comprise a current frame encoded using a selected reference frame from reference frames preceding the current frame in display order, the reference frames comprising a good reference frame. The good reference frame is a reference frame known to the encoder to be error-free. In some implementations, for a reference frame to be a good reference frame, the reference frames needed by it for decoding are also error-free. By receiving we can mean inputting, acquiring, reading, accessing or in any manner receiving an encoded video bitstream. The encoded video bitstream can be encoded by computing device 12 using encoder 300 and transmitted via network 16, for example.

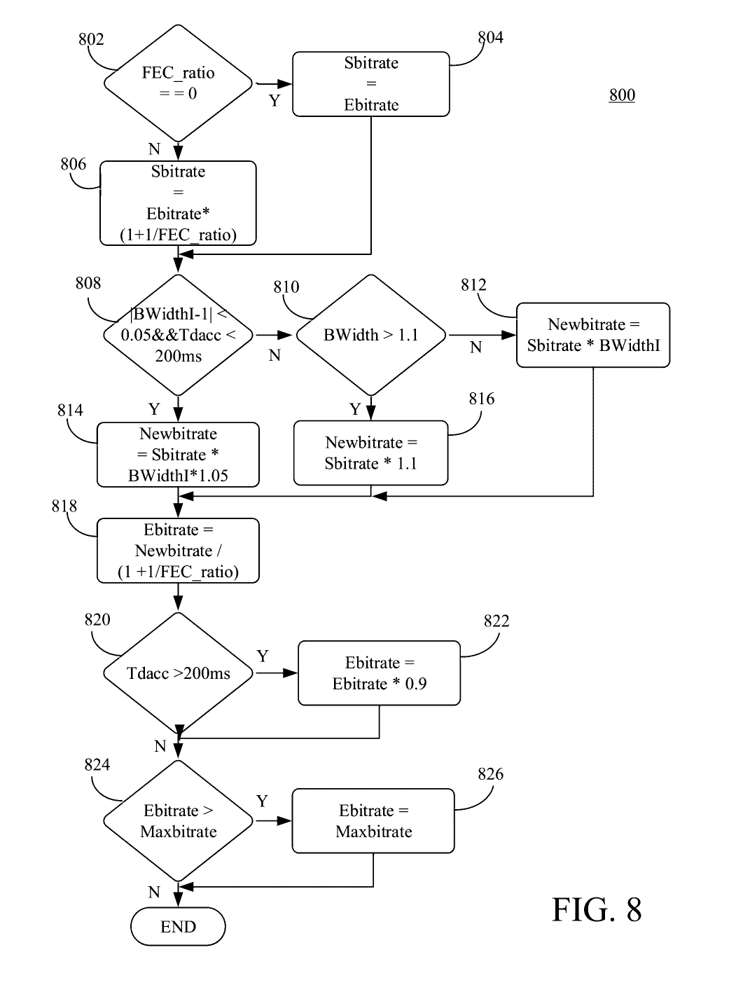

Encoding parameters can include parameters that can be input to the encoding process to adjust the resulting output bitstream with regard to bandwidth and error correction. For example, the encoding parameters can include, without limitation, bit rate, FEC ratio, reference frame selection and key frame selection. For another example, the encoding parameters can include estimated bandwidth determined based on the bandwidth data included in the aforementioned received data. An example of encoding parameter selection using network parameters is shown by process 800 shown in FIG. 8.

In some implementations, the selected reference frame can be selected from preceding reference frames, in display order, of the current frame. The preceding reference frames can include at least one good reference frame, defined as a reference frame, known to the encoder, that can be decoded free of error. For example, the selected reference frame can be a good reference frame, and that good reference frame can be used for encoding the current frame. For another example, the good reference frame as the selected reference frame can be used for encoding a number of consecutive frames including the current frame, in which case the number of consecutive frames encoded using the same good reference frame is adaptively selected based on one or more of the following data: packet loss rate, bandwidth data, and FEC strength. The FEC strength, for example, can be determined by a FEC encoder based on the received data for encoding video bitstream 322 from decoding computing device 14, and the FEC encoder can adaptively change the FEC strength and packet size based on the received data (e.g., feedback information). In some implementations, the encoding parameters determined in operation 704 can be updated based on one or more of the following data: FEC strength, bitrate, and the number of consecutive frames encoded using the same good references frame.

At operation 506 process 500 can decode, at the computing device 14, the video bitstream using the selected reference frame.

In some implementations, Call and Answer messages can be out of band packets that accompany the encoded video bitstream that include packets having a sequence number and a time stamp and a message size in bits based on the variable “Psize” and on a predetermined maximum video rate “Maxbitrate” stored in a configuration file associated with process 500. Psize can be determined, for example, based on Maxbitrate according to the following pseudo code:

```
if (Maxbitrate <= 300Kbps)
    Psize = 400;
else if (Maxbitrate <=1Mbps)
    Psize = 800;
else
    Psize = 1200;
```

By setting Psize in this fashion, network bandwidth can be estimated prior to sending Call and Answer messages, thereby preventing the Call and Answer messages from flooding the network by sending too many packets too quickly when the network is slow. Call and Answer messages can be used to determine the true network bandwidth if sufficient number of packets including Call and Answer messages are sent by an encoding computing device 12 and received by a decoding computing device 14 via a network 16. Process 500 can be designed to handle three times the desired bitrate in one direction, while not flooding the network too long for any network bandwidth over 100 Kbps.

Aspects of disclosed implementations can keep track of Call and Answer messages by assigning a unique packet number to each packet including Call and Answer messages starting with zero and increasing by one for each video stream. A timestamp can also be included in each packet including Call and Answer messages, also starting at zero and increasing with at least millisecond (ms) resolution for each packet sent or some temporal resolution available with high resolution timers associated with computing devices 12 or 14.

According to some implemenations, two groups of Call and Answer messages can be created. The first groups can include 25 packets and the second groups can include 10 packets. In an example, a group of 25 Call messages can be created and sent by an encoding computing device 12 at approximately 100 ms intervals. Using the formula:

Maxbitrate=(25*8*Psize)/0.1={0.8 Mbps,1.6 Mbps,2.4 Mbps}

it can be determined that the maximum bit rate that can be estimated using values of Psize calculated by the pseudo code above are 0.8 Mbps, 1.6 Mbps or 2.4 Mbps. For networks with bandwidth higher than Maxbitrate, the network bandwidth can be estimated at Maxbitrate. Following the first group of 25 packets, aspects of disclosed implementations can wait approximately 400 ms before sending a second group of 10 packets.

The time it takes to transmit and receive the first and second groups of packets can indicated the network bandwidth. For example, a 100 Kbps network can take approximately one second to transmit 35 packets included in the first and second groups, assuming 400 bytes (Psize=400) for each packet. At 1200 bytes (Psize=1200) the same network can take approximately three seconds. Transmitting and receiving Call and Answer message packets can take place at the beginning of a video stream, meaning that a user can be waiting until the Call and Answer messages are processed before the video begins. Other implementations can use, for example, the first two frames of encoded video bitstream data to estimate network bandwidth following an initial estimate of network bandwidth. The data in the video bitstream can be real encoded video data or random data.

In addition, process 500 can timestamp each packet with an additional timestamp indicating the time it was received. For example, process 500 can begin receiving and storing packets when the first video bitstream begins and continue until either 25 packets are received or three seconds have elapsed. If fewer than 25 packets have been received they can be considered lost. The average bandwidth can be calculated by the following equation:

Bandwidth=(24−Nloss)*Psize/(Tlast−Tfirst)

Bandwidth is calculated in Kbps and Nloss is the total number of packets lost in the first 25 packets. This does not include any packets lost in the second groups of 10 packets. Tlast is the arrival timestamp of the last packets immediately before packet 25, not including lost packets, measured in ms and Tfirst is the arrival time of the first packet received in ms. Note that the relative difference in arrival time from the first packet to the last packet is used to determine bandwidth, since the time required to transmit the first packet cannot be known.

Since audio and video both occupy the same network bandwidth, aspects of disclosed implementations can perform dynamic bandwidth estimation. Messages sent from a decoding device 14 to and encoding computing device 12 during transmission of a video bitstream 322 from encoding computing device 12 to decoding computing device 14 can be called back-channel messages. Aspects of disclosed implementations use back channel message transmission and processing to determine network parameters associated with network bandwidth that can be used to optimize encoding parameters.

Encoding parameters that can be re-calculated based on the bandwidth, packet loss ratio and round trip time include adaptive coding length, FEC ratio, video encoder bitrate, spatial resolution (frame size), temporal resolution (frame rate).

Aspects of disclosed implementations can adjust the encoding parameters to match network bandwidth, packet loss ratio and round trip time and thereby optimize the encoding process to provide the highest quality decoded video at decoding computing device 14 for given network bandwidth, packet loss ratio and round trip time. By determining network parameters from time to time based on timestamps applied to the packets of portions of the video bitstream 322, changes in network bandwidth that can occur while portions of the video bitstream 322 is being received can be detected. For example, encoding computing device 12 can be a server and decoding computing device 14 can be a mobile phone in motion and subject to changing network conditions including changes in network bandwidth.

When encoding computing device 12 is transmitting a video bitstream 322 encoded with encoding parameters based on an expected bandwidth that is higher than the actual bandwidth of the network, the video bitstream 322 will not be able to be transmitted quickly enough and therefore the network latency will increase. This can be identified by detecting network latency and the calculation of bandwidth from network latency is relatively straightforward. Detection of actual bandwidth that is greater than the expected bandwidth can be more difficult. Without reliable and efficient detection of actual bandwidth being greater than expected bandwidth a decoder that dynamically detects network bandwidth can only go down in time and never go back up.

Bandwidth detection can be based on the assumption that if the expected bandwidth is greater than the available bandwidth, network latency will increase proportionally, while if expected bandwidth is less than the available bandwidth, network latency will not increase. For example if the expected bandwidth is 200 Kbps and the available bandwidth is 100 Kbps, it will take two seconds to transmit one second of video, or some packets will have to be dropped. If the expected bandwidth is 200 Kbps and the available bandwidth is greater than 200 Kbps, it will take one second to transmit one second of video. This can be determined by comparing timestamps included in the packets of a video bitstream 322 with local timestamps created when the video bitstream 322 is received at decoding computing device 14. The relative difference between corresponding timestamp can indicate if the maximum expected bandwidth was reached.

Aspects of disclosed implementations can adaptively respond to changes in network bandwidth both increasing and decreasing by detecting changes network bandwidth from time to time while the video bitstream is being transmitted using back channel messaging at a rate that is high enough to maintain video quality despite changes in network bandwidth without decreasing bandwidth excessively by sending too many back channel messages. Aspects can decrease decoding parameters such as bit rate when network bandwidth is detected decreasing and increase decoding parameters such as bit rate by a small amount when network latency is as expected. In this way, by repeatedly sampling network bandwidth in the manner discussed above and increasing encoding parameters, for example the encoding bitrate by a small amount each time the network is performing as expected, the maximum bandwidth of the network can be determined in a relatively short period of time.

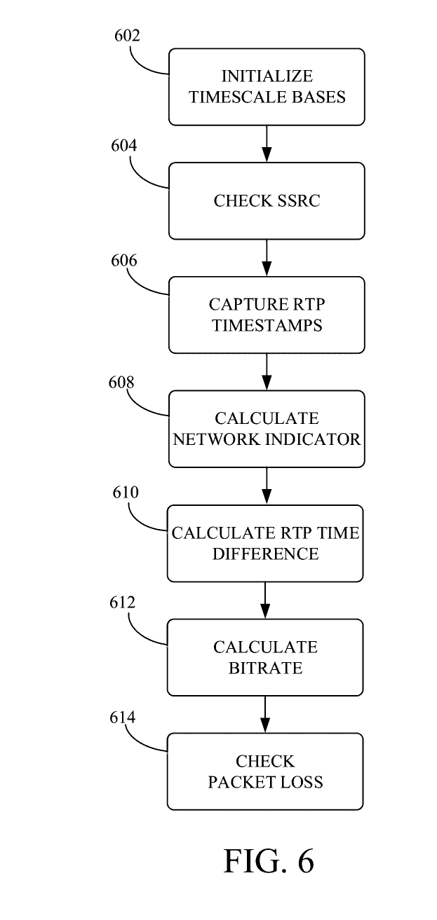

At operation 514 process 500 can determine network parameters using the process described in FIG. 6. In FIG. 6, process 600 can determine network parameters by performing bandwidth estimation using a sliding window based on local time at the decoding computing device 14. The window length can be two seconds or any other predetermined window length programmatically provided to process 600. At operation 602, upon receiving the first packet associated with a video bitstream 322, process 600 can initialize times scale bases: T0=local time when the first packet was received and Trtp0=the round trip packet (RTP) time stamp of the first video packet of video bitstream 322. At operation 604, process 600 checks the synchronization source (SSRC) of the first packet and last packet in the two second window. If they are the same, continue with the bandwidth estimate, otherwise, reset T0 and Trtp0 to synchronize with the first packet of the new SSRC. No back channel message will be sent in this case since the base of the timestamp has changed making the bandwidth estimate invalid.

At operation 606 process 600 can capture the RTP time stamp gap of the first packet (Tr0) and the last packet (Tr1) of the two second window in local time by calculating

Tgap=Tr1−Tr0 (5)

using a high precision timer having a clock speed of 90 KHz or higher and

Twindow=2*90000 (6)

to convert the time window in seconds to the same time scale as the RTP timestamp.

At operation 608 process 600 can calculate a bandwidth indicator as a function of Tgap and Twindow. Network indicator can be calculated as a ratio of Twindow to Tgap, with the following results: a. bandwidth indicator <1, indicating a network delay increase, caused by a network bandwidth shortage. b. bandwidth indicator=1, indicating the network is able to transmit the video without a problem. There potentially can be bandwidth for a higher bitrate. c. bandwidth indicator >1, indicating the arrival of a burst of packets faster than real time. This can be an indication of a network jam currently getting better. This can be the result, for example, a file download being stopped or a bandwidth limiter being released. The arrival of a burst of packets can also indicate an excessively jittery network condition. For most network jitter conditions, the bandwidth indicator will be close to 1.

At operation 610 process 600 can calculate the accumulated time difference Tdacc in RTP time and local time according to the equation:

Tdacc=(Tr1−Trtp0)−(Tcurrent−T0) (7)

where Tr1 is the timestamp of the last packet of the current window, Trtp0 is the timestamp of the first packet of the video stream 322 with the same SSRC as the last packet, Tcurrent is the current local time and T0 is the local time when the packet was received. A continuous increase in Tdacc can indicate the network bandwidth is not enough to transmit the video bitstream. This can be used to correct the two second window adjustment where a small delay increase can not be detected.

At operation 612 the actual received bitrate (Rbitrate) can be calculated by dividing the total number of bits received in the packets, including forward error correction (FEC) packets, buy the total time duration of the window, in this example two seconds. At operation 614 the total number of packets and the total number of packets lost can be checked by examining packet sequence numbers. The total number of packets (Ptotal) and the total number of lost packets (Plost) can be obtained by subtracting the first RTP sequence number from the last RTP sequence number and comparing this to a count of packets received, for example. Ptotal and Plost can be combined into Packetlossratio.

Following operation 612, process 600 can return to operation 516 of process 500 in FIG. 5. At operation 516 network parameters determined by process 600 at operation 514 can be transmitted to encoding computing device 12 via a back channel message. The network parameters can include bandwidth indicator, Tdacc, Rbitrate and Packetlossratio as described above. Following operation 516, if decoding computing device 14 is still receiving video bitstream 322 data, process 500 can return to operation 510 to receive the next video bitstream. If process 500 determines at operation 518 that no more video bitstream 322 data is being received at decoding computing device 14, process 500 can end.

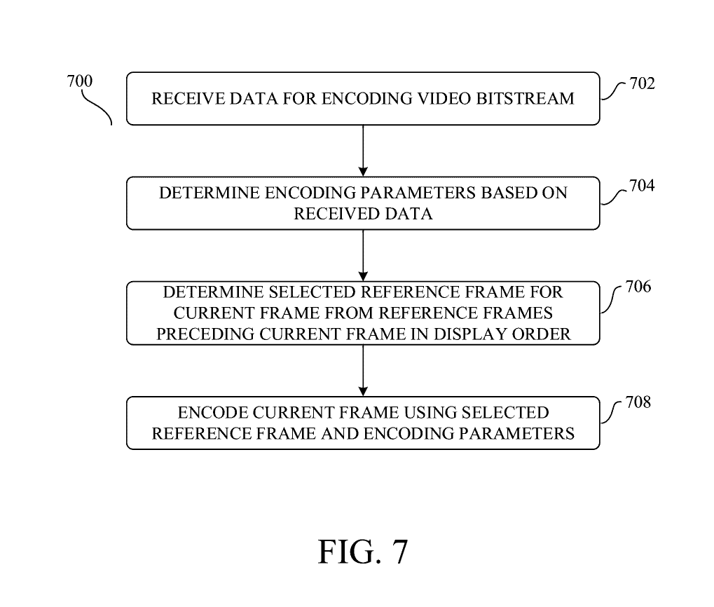

FIG. 7 is flowchart diagram of a process 700 for encoding a video stream 200 according to disclosed implementations. Process 700 can be performed by an encoding computing device 12 for example. The flowchart diagram in FIG. 7 shows several operations included in process 700. Process 700 can be accomplished with the operations included herein or with more or fewer operations than included here. For example, operations can be combined or divided to change the number of operations performed. The operations of process 700 can be performed in the order included herein or in different orders and still accomplish the intent of process 700.

Process 700 begins at operation 702 by receiving data for encoding video bitstream 322 from decoding computing device 14. In some implementations, the received data can include packet loss ratio, round trip delay, receiving bitrate, bandwidth data, data indicating whether a reference frame is good or bad, or any combination of the above. The received data can be used to determine encoding parameters by encoding computing device 12. Other data that purports such use is not limited to the description set forth herein.

At operation 704, the received data is used to determine encoding parameters. Encoding parameters can include parameters that can be input to the encoding process to adjust the resulting output bitstream with regard to bandwidth and error correction. For example, the encoding parameters can include, without limitation, bit rate, FEC ratio, reference frame selection and key frame selection. For another example, the encoding parameters can include estimated bandwidth determined based on the bandwidth data included in the aforementioned received data. An example of encoding parameter selection using network parameters is shown by process 800 shown in FIG. 8.

At operation 706, encoding computing device 12 determines a selected reference frame for encoding a current frame of video bitstream 322. In some implementations, the selected reference frame can be selected from preceding reference frames, in display order, of the current frame. The preceding reference frames can include at least one good reference frame, defined as a reference frame, known to the encoder, that can be decoded free of error. For example, the selected reference frame can be a good reference frame, and that good reference frame can be used for encoding the current frame. For another example, the good reference frame as the selected reference frame can be used for encoding a number of consecutive frames including the current frame, in which case the number of consecutive frames encoded using the same good reference frame is adaptively selected based on one or more of the following data: packet loss rate, bandwidth data, and FEC strength. The FEC strength, for example, can be determined by a FEC encoder based on the received data for encoding video bitstream 322 from decoding computing device 14, and the FEC encoder can adaptively change the FEC strength and packet size based on the received data (e.g., feedback information). In some implementations, the encoding parameters determined in operation 704 can be updated based on one or more of the following data: FEC strength, bitrate, and the number of consecutive frames encoded using the same good references frame.

At operation 708, the current frame of video stream 322 is encoded using the selected reference frame and the encoding parameters. In some implementations, the encoding process can be set forth in the following description.

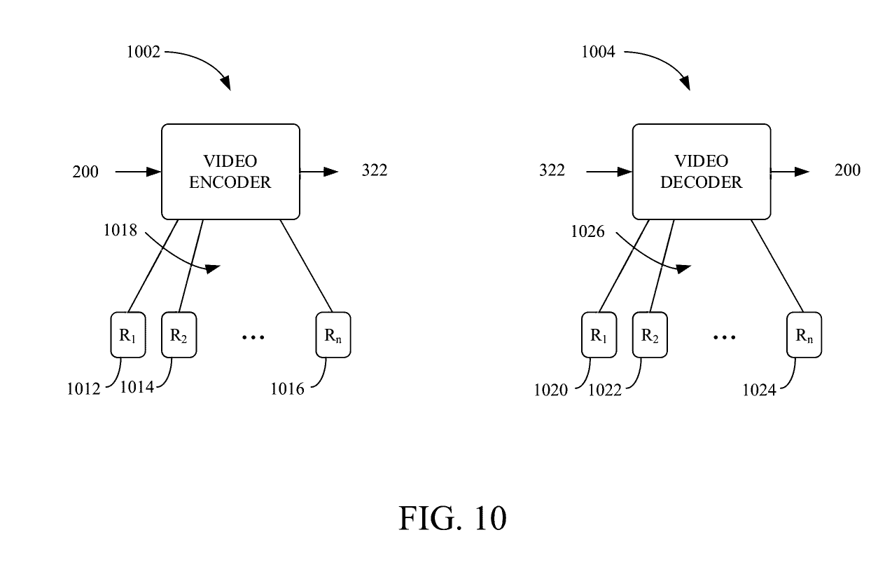

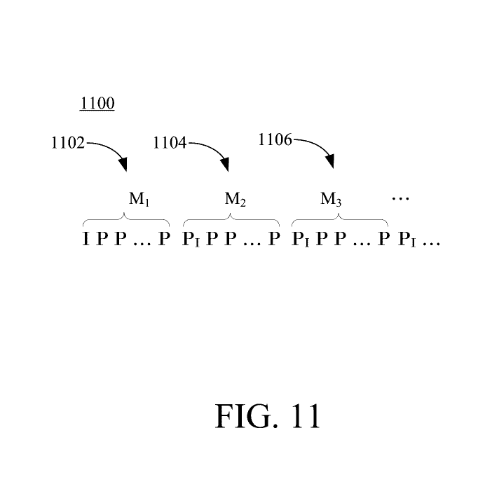

For example, a first portion of video bitstream 322 can be encoded including Call messages that can be transmitted as part of video bitstream 322 and received by decoding computing device 14. Decoding computing device 14 can determine first network parameters based on the received Call messages and send Answer messages back to the via a back channel. Encoding computing device 12, for example, can receive the first network parameters and calculate next encoding parameters, then encode a second portion of video bitstream 322 with the determined next encoding parameters. The second portion of the video bitstream can be encoded using second encoding parameters based on the first network parameters. For example, the first encoding parameters can include a first number of reference frames, and the second encoding parameters can include a second number of reference frames, as will be further discussed in FIGS. 10 and 11. After being encoded, the second portion of video bitstream 322 can be transmitted by encoding computing device 12 via network 16 to decoding computing device 14. Decoding computing device, for example, can determine second network parameters and send the determined second d network parameters back to encoding computing device 12 via back channel messages.

Upon receiving back channel messages from a decoding computing device 14, for example, encoding computing device 12 can analyze the back channel messages and, in combination with other messages and stored parameters including statistics can determine second encoding parameters to be used in encoding the second portion of video bitstream 322. For example, a good reference frame, or any reference frame can be chosen for encoding, depending on coding efficiency and bandwidth condition at the time. Encoding computing device 12 can switch between, for example, the different options of reference frames, and different number of frames in each group that use the same reference frame to better adjust to the current network condition based on the feedback information.

Encoding computing device 12 (sender) can, for example, switch between using a known good reference frame and using any reference frame (e.g., the frame immediately preceding the current frame) for encoding a current frame of the video bitstream 322. The selection can be based on, for example, tradeoffs between coding efficiency and quality. For example, when selecting any reference frame (e.g., the frame immediately preceding the current frame), better coding efficiency is achieved but the decoded video can have lower quality due to errors occurred during transmission.

FIG. 8 is flowchart diagram of a process 800 for determining bit rate according to disclosed implementations. Process 800 can be performed by an encoding computing device 12 for example. The flowchart diagram in FIG. 8 shows several operations included in process 800. Process 800 can be accomplished with the operations included herein or with more or fewer operations than included here. For example, operations can be combined or divided to change the number of operations performed. The operations of process 800 can be performed in the order included herein or in different orders and still accomplish the intent of process 800.

As discussed above, (FEC) is an error correction technique that adds additional packets to the packets of a video bitstream to permit a receiver to recover lost or corrupted packets without requiring retransmission of the packet data. Each packet of the output video bitstream can be protected by zero or more packets of FEC data, e.g. a packet of the output video bitstream can be either unprotected by FEC packet data or protected by multiple FEC packets depending upon the predetermined importance of the packet in decoding the video bitstream. For example, packets including motion vectors can be protected by more FEC packet data than coefficients representing pixel data for an intermediate frame. The process of protecting the packets of a video bitstream using FEC packets can be controlled by several parameters, one of which, FEC_ratio, describes the ratio between video bitstream data packets and FEC packets.

Process 800 begins at operation 802 with the assumptions that FEC_ratio is set to the current value being used to protect the current video bitstream 322, the current encoder bit rate is set to Ebitrate and the predetermined maximum bit rate permitted is Maxbitrate. At operation 802, process 800 tests FEC_ratio to see if it is 0, and if so, at operation 804 sets the variable Sbitrate=Ebitrate. At operation 806, if FEC_ratio˜=0, Sbitrate=Ebitrate(1+1/FEC_ratio). This has the effect of incrementing the current bit rate proportional to the amount of FEC protection.

At operation 808 received network parameter bandwidth indicator (BWidthI) is normalized to 0 and tested to see if it is less than 0.05 and that the received network parameter current accumulated time difference (Tdacc) is less than 200 ms, for example. If these are both true, the network is handling the current bitrate, therefore at operation 814 process 800 can increase the expected bitrate by about 5% by setting the variable Newbitrate=Sbitrate*BWidthI*1.05. If the test at operation 808 is false, at operation 810 bandwidth indicator BWidthI is tested to see if it is greater than 1.1 and if so, the network can be on a fast burst as discussed above, and therefore at operation 816 process 800 can probe the network to see if this means the network bandwidth has increased by setting the variable Newbitrate to Sbitrate*1.1, a 10% increase in bit rate. If at operation 810 it is determined that BWidthI<1.1, the network delay is increasing, therefore the bit rate is adjusted down by setting Newbitrate=Sbitrate*BWidthI.

At operation 818 the expected bit rate Ebitrate is set to be Newbitrate/(1+1/FEC_ratio) to compensate for the additional bits to be added to the bitstream by FEC. At operation 820 the accumulated delay is tested to see if it is greater or equal to its expected value of 200 ms. If it is, then at operation 822 the network delay is increasing and the expected bit rate Ebitrate is set to 90% of its value. If at operation 820 the network delay is less than its expected value, at operation 824 Ebitrate is checked to see if it is greater than the permitted maximum Maxbitrate. If so, at operation 826 it is reduced to be equal to Maxbitrate. Following these operations the process 800 can return to operation 716 of FIG. 7 to complete process 700.

Returning to FIG. 7, at following determination of second encoding parameters at operation 716, process 700 can determine at operation 718 if additional portions of the video bitstream 322 remains to be encoded. If true, process 700 can return to operation 710 to encode a second portion of the video bitstream 322 using encoding parameters determined at operation 716. As discussed above, the frequency with which encoding parameters are determined will determine how smoothly and quickly process 700 can respond to changes in network bandwidth, while not decreasing network bandwidth significantly by adding back channel messages. If at operation 718 process 700 determines that no further video stream data remains, process 700 can end.

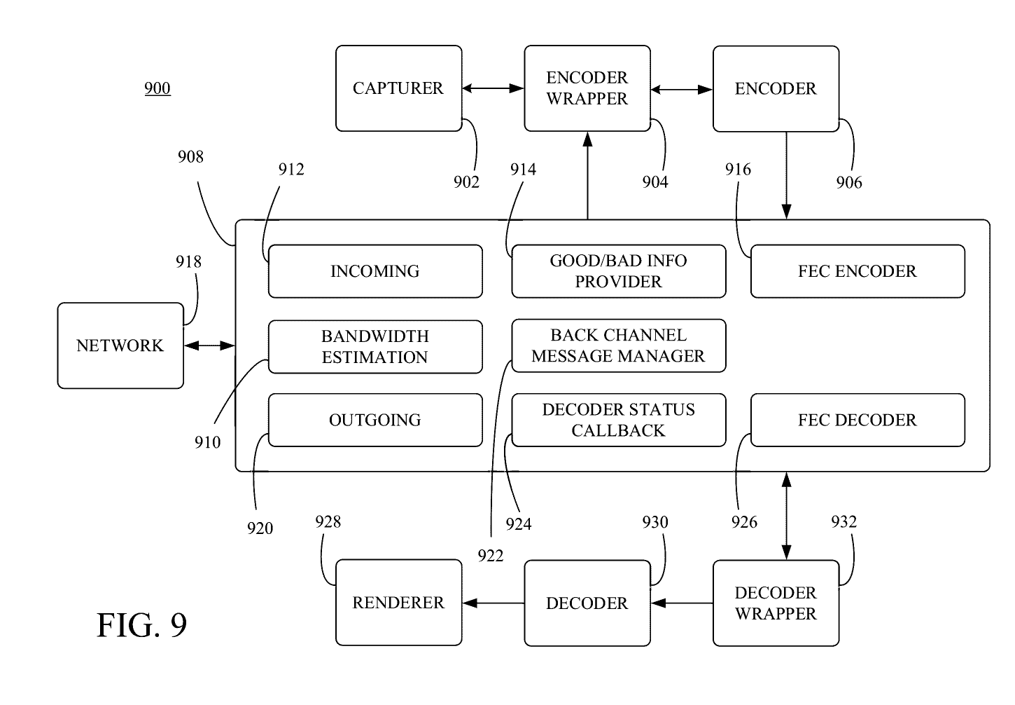

FIG. 9 is an example of a codec 900 according to disclosed implementations. Codec 900 can implement processes 500, 600, 700 and 800 as shown in to FIGS. 5, 6, 7 and 8 and described above. Codec 900 can be implemented using a computing device 12, 14. Codec 900 can either encode a video stream 200 or decode a video bitstream 322 depending upon how it is instructed at run time. Codec 900 can acquire video stream data 200 using a capturer 902. Capturer 902 can acquire uncompressed video stream data either via live data acquisition, for example with a video camera, or by reading video stream data from a storage device or a network, for example.

When codec 900 is operating as an encoder, capturer 902 can pass the uncompressed video stream 200 to encoder wrapper 904. Encoder wrapper 904 can examine the input uncompressed video stream 200, receive parameters from back channel manager 908 and read stored parameters and statistics from non-transitory storage devices to determine encoder parameters to send to encoder 906 along with the video stream 200. Encoder 906 can be an encoder similar to encoder 300 in FIG. 3. Encoder 906 can use the received encoder parameters to encode the video stream 200 to result in an encoded video bitstream 322 having an expected bit rate selected by back channel manager 908. Encoder can pass the packets included in the encoded video bitstream to FEC encoder 916, where FEC packets can be created and added to the output video bitstream according to FEC encoding parameters including FEC_ratio for example. The FEC encoder can then pass the packets included in the output video bitstream to the outgoing 920 data module for transmission via network 918.

When codec 900 is operating as a decoder, packets included in an encoded video bitstream 322 can be received from network 918 by incoming 912 data module and passed to FEC decoder 926. FEC decoder can strip FEC packets from the incoming video bitstream and restore lost or corrupt packets if necessary and if possible. FEC decoder can send information regarding lost or unrecoverable packets to good/bad info provider 914, for example. FEC decoder can then send the video bitstream to decoder wrapper 932 along with decoder parameters. Decoder wrapper can examine the video bitstream and return parameter information, for example timestamps and sequence numbers of packets, to decoder status callback 924. Decoder 930 can be similar to decoder 400 shown in FIG. 4. Decoder 930 can decode the video bitstream 322 according to the passed decoder parameters and output the decoded video stream to render 928, where the video stream can be rendered for display on a display device attached to decoding computing device 14 or stored on a non-transitory storage device, for example.

In addition to encoding and decoding video data, codec 900 includes back channel message manager 922. Back channel message manager 922 is responsible for creating, transmitting and receiving Call and Answer messages as described above. When operating in encoding mode, back channel message manager 922 can transmit Call messages via outgoing 920 data module to the network 918 and receive Answer messages from the network 918 via incoming 912 data module. The received Answer messages can be analyzed by bandwidth estimation 910 module to determine network parameters. The back channel message manager 922 can send and receive back channel messages via incoming 912 and outgoing 920 ports and manage the calculation and collection of network parameters using decoder status callback 924 and bandwidth estimation 910 to be used in setting encoder parameters. Operating in decoding mode, back channel message manager 924 can receive Call messages from network 918 using incoming 912 port, determine network parameters using bandwidth estimation 910 and create Answer messages to transmit via outgoing 920 port and network 918.

Bandwidth estimation 910 module can estimate available network bandwidth based on received and calculated network parameters including round trip delay, decoder side receiving bit rate, packet loss ratio and decoder side bandwidth indicators including bandwidth indicator and accumulated indicator. Encoding parameters determined by back channel controller 908 can include FEC strength, bit rate, number of reference frames and which reference frames to use. The FEC encoder can adaptively change it FEC strength and packet size according to encoding parameters determined by the back channel controller 908.

One aspect of codec 900 is the ability to choose the reference frames used for inter prediction dynamically to suit changing network conditions. FIG. 10 shows an encoder 1002 inputting a video stream 200 to be encoded to a video bitstream 322. Video encoder 1002 can use some number 1018 of reference frames R₁, R₂, . . . , Rₙ 1012, 1014, 1016 to encode video bitstream 322. Using a greater number of reference frames can improve the quality of the transmitted video bitstream but can require greater network bandwidth. Adjusting the number of reference frames to use 1018 can match the number of reference frames required to be transmitted to the available network bandwidth. Video decoder 1004 can adjust the number 1026 of decoded reference frames R₁, R₂, . . . Rₙ 1020, 1022, 1024 used to decode video bitstream 322 to match the number of reference frames used to encode the video bitstream by encoder 1002 by receiving parameters describing the number of frames and other data associated with the reference frames from encoder 1002 either directly in the video bitstream of via a back channel message.

FIG. 11 shows an example of selecting a reference frame in accordance with disclosed implementations. FIG. 11 shows a video stream 1100, including groups of frames M₁, M₂ and M₃. Group M₁ includes an intra-coded reference frame I and predicted frames P. The predicted frames P can be reconstructed using information included in I and prediction information encoded in the video bitstream. Group M₂ includes a first frame P₁, where frame P₁ is encoded using a known good reference frame in the decoder buffer. A reference frame is a good reference frame if the decoder (receiver) is able to decode the reference frame without any error. In some implementations, for a reference frame to be a good reference frame, the needed reference frames are also without any error. The good reference is a known good reference frame if the good reference frame is known to the encoder to be error-free. The good reference frame does not need to be an I frame, and can be reconstructed from previously (correctly) decoded frames such as frame I from group M₁. This means that a separate I frame does not have to be transmitted for frame group M₂. For example, once the decoder (receiver) determines that P₁ is a good reference frame in the decoder buffer, it can indicate to the encoder (sender) that P₁ is a good reference to the encoder, either directly in the bitstream or via a back channel message. Thus, the encoder (sender) knows that P₁ is a good reference frame and can be used for predicting the subsequent frames. Likewise, frame group M₃ includes a frame P₁ that can also be reconstructed from a known good reference frame indicated by the back channel messages at run time, therefore not requiring transmission of a separate I frame to reconstruct the predicted frames P of group M₃. As shown by the ellipses in FIG. 11, this scheme can be continued further for additional groups of frames.

Through the back channel message manager 908, the video encoder can use feedback information from the decoder to determine which reference frame should be used for encoding. For example, a good reference frame, or any reference frame can be chosen for encoding, depending on coding efficiency and bandwidth condition at the time. The encoder can switch between, for example, the different options of reference frames, and different number of frames in each group that use the same reference frame to better adjust to the current network condition based on the feedback information.

Encoder (sender) can, for example, switch between using a known good reference frame and using any reference frame (e.g., the frame immediately preceding the current frame) for encoding a current frame of the video bitstream 322. The selection can be based on, for example, tradeoffs between coding efficiency and quality. For example, when selecting any reference frame (e.g., the frame immediately preceding the current frame), better coding efficiency is achieved but the decoded video can have lower quality due to errors occurred during transmission.

When the selected reference frame is a good reference frame, the same good reference frame can be used for encoding, for example, a number of consecutive frames including the current frame. The number of consecutive frames (e.g., M₂ or M₃ in FIG. 11) encoded using the same good reference frame can be adaptively selected based on packet loss rate, bandwidth data, FEC strength, or any combination of the above. For example in FIG. 11, the number of frames in each group such as M₁ M₂ M₃ . . . Mᵢ can be dynamically changed at a frame boundary, and the value of each group M₁ M₂ M₃ . . . Mᵢ can be determined by packet loss rate, bandwidth, FEC strength, or any combination of above. The encoding parameters can be updated based on, for example, FEC strength, bitrate, and the number of consecutive frames encoded using the same good references frame, or any combination of the above.

In some implementations, the FEC strength can be determined by a FEC encoder based on the data received from the decoding computing device for encoding the video bitstream, and the FEC encoder can adaptively change the FEC strength and packet size based on the data received from the decoding computing device for encoding the video bitstream (e.g., feedback information). The data received for encoding the video bitstream (e.g., feedback information) can further include, for example, packet loss ratio, round trip delay, receiving bitrate, bandwidth data, and data indicating whether a reference frame is good or bad, etc. The encoding parameters can, for example, include estimated bandwidth, which can be determined based on the bandwidth data received in the feedback information.

The implementations of encoding and decoding described above illustrate some exemplary encoding and decoding techniques. However, encoding and decoding, as those terms are used in the claims, could mean compression, decompression, transformation, or any other processing or change of data.

The words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same implementation unless described as such.

The implementations of transmitting station 12 and/or receiving station 30 and the algorithms, methods, instructions, and such stored thereon and/or executed thereby can be realized in hardware, software, or any combination thereof. The hardware can include, for example, computers, intellectual property (IP) cores, ASICs, programmable logic arrays, optical processors, programmable logic controllers, microcode, microcontrollers, servers, microprocessors, digital signal processors or any other suitable circuit. In the claims, the term “processor” encompasses any of the foregoing hardware, either singly or in combination. The terms “signal” and “data” are used interchangeably. Further, portions of transmitting station 12 and receiving station 30 do not necessarily have to be implemented in the same manner.

Further, in one implementation, for example, transmitting station 12 or receiving station 30 can be implemented using a general purpose computer/processor with a computer program that, when executed, carries out any of the respective methods, algorithms and/or instructions described herein. In addition or alternatively, for example, a special purpose computer/processor can be utilized which can contain specialized hardware for carrying out any of the methods, algorithms, or instructions described herein.

Transmitting station 12 and receiving station 30 can, for example, be implemented on computers in a screencasting system. Alternatively, transmitting station 12 can be implemented on a server and receiving station 30 can be implemented on a device separate from the server, such as a cell phone or other hand-held communications device. In this instance, transmitting station 12 can encode content using an encoder 70 into an encoded video signal and transmit the encoded video signal to the communications device. In turn, the communications device can then decode the encoded video signal using decoder 100. Alternatively, the communications device can decode content stored locally on the communications device, such as content that was not transmitted by transmitting station 12. Other suitable transmitting station 12 and receiving station 30 implementation schemes are available. For example, receiving station 30 can be a generally stationary personal computer rather than a portable communications device and/or a device including encoder 70 can also include decoder 100.

Further, all or a portion of implementations of the present invention can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described implementations have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method for encoding a video bitstream with a computing device comprising:
receiving, from a decoding computing device, data for encoding the video bitstream;
determining encoding parameters based on the data for encoding the video bitstream;
determining, by the computing device and for encoding a current frame of the video bitstream, a selected reference frame from reference frames preceding the current frame in display order, the reference frames comprising a good reference frame, wherein the good reference frame is a reference frame known to the encoder to be error-free; and
encoding the current frame of the video bitstream using the selected reference frame and the encoding parameters.

2. The method of claim 1, wherein the selected reference frame is a good reference frame, and the same good reference frame is used for encoding a number of consecutive frames including the current frame.

3. The method of claim 2, wherein the number of consecutive frames encoded using the same good reference frame is adaptively selected based on one or more of: packet loss rate, bandwidth data, and FEC strength.

4. The method of claim 3, further comprising:
updating the encoding parameters based on at least one of: FEC strength, bitrate, and the number of consecutive frames encoded using the same good references frame.

5. The method of claim 3, wherein the FEC strength is determined by a FEC encoder based on the data received from the decoding computing device for encoding the video bitstream.

6. The method of claim 5, wherein the FEC encoder adaptively changes the FEC strength and packet size based on the data received from the decoding computing device for encoding the video bitstream.

7. The method of claim 1, wherein the data received for encoding the video bitstream further comprises at least one of packet loss ratio, round trip delay, receiving bitrate, bandwidth data, and data indicating whether a reference frame is good or bad.

8. The method of claim 7, wherein the encoding parameters include estimated bandwidth determined based on the bandwidth data.

9. A method for decoding a video bitstream with a computing device comprising:
transmitting, to an encoding computing device, data for encoding the video bitstream;
receiving, from the encoding computing device, the encoded bitstream, wherein the encoded bitstream comprises a current frame encoded using a selected reference frame from reference frames preceding the current frame in display order, the reference frames comprising a good reference frame, wherein the good reference frame is a reference frame known to the encoder to be error-free; and
decoding, at the computing device, the video bitstream using the selected reference frame.

10. The method of claim 9, wherein the data for encoding the video bitstream comprises one or more of: data indicating whether a reference frame is good or bad, packet loss ratio, round trip delay, receiving bitrate, and bandwidth data.

11. The method of claim 9, further comprising:
receiving, by the computing device and from the encoding computing device, data indicating that a video bitstream is to be encoded.

12. The method of claim 9, wherein the selected reference frame is a good reference frame, and the same good reference frame is used for encoding a number of consecutive frames including the current frame.

13. The method of claim 12, wherein the number of consecutive frames encoded using the same good reference frame is adaptively selected based on one or more of: packet loss rate, bandwidth data, and FEC strength.

14. The method of claim 9, wherein decoding includes processing FEC packets to detect or correct missing or corrupt video bitstream data.

15. An apparatus for encoding a video bitstream comprising:
a memory;
a processor operative to execute instructions stored in the memory to:
receive, from a decoding computing device, data for encoding the video bitstream;
determine encoding parameters based on the data for encoding the video bitstream;
determine, for encoding a current frame of the video bitstream, a selected reference frame from reference frames preceding the current frame in display order, the reference frames comprising a good reference frame, wherein the good reference frame is a reference frame known to the encoder to be error-free; and
encode the current frame of the video bitstream using the selected reference frame and the encoding parameters.

16. The apparatus of claim 15, wherein the selected reference frame is a good reference frame, and the same good reference frame is used for encoding a number of consecutive frames including the current frame.

17. The apparatus of claim 16, wherein the number of consecutive frames encoded using the same good reference frame is adaptively selected based on one or more of: packet loss rate, bandwidth data, and FEC strength.

18. The apparatus of claim 17, further comprising instructions to update the encoding parameters based on at least one of: FEC strength, bitrate, and the number of consecutive frames encoded using the same good references frame, wherein the FEC strength is determined by a FEC encoder based on the data received from the decoding computing device for encoding the video bitstream, and the FEC encoder adaptively changes the FEC strength and packet size based on the data received from the decoding computing device for encoding the video bitstream.

19. The apparatus of claim 15, wherein the data received for encoding the video bitstream further comprises at least one of packet loss ratio, round trip delay, receiving bitrate, bandwidth data, and data indicating whether a reference frame is good or bad, and wherein the encoding parameters include estimated bandwidth determined based on the bandwidth data.
